(19) United States
(12) Patent Application Publication
(10) Pub. No.: US 2007/0256570 A1
(43) Pub. Date: Nov. 8, 2007

(54) Cooking Implement

(76) Inventor: Choonok Yang, Cheonan-si (KR)

Correspondence Address: IPLA P.A., 3580 WILSHIRE BLVD., 17TH FLOOR, LOS ANGELES, CA, 90010, US

(21) Appl. No.: 11/577,403

(22) PCT Filed: Jun. 2, 2005
(86) PCT No.: PCT/KR05/01652

§ 371 Date: Apr. 17, 2007

(30) Foreign Application Priority Data
Oct. 19, 2004 (KR) 20-2004-0029536
Dec. 22, 2004 (KR) 10-2004-0110246

(51) Int. Cl. A47J 27/00

(52) U.S. Cl. 99/324

(57) ABSTRACT

Disclosed herein is a cooking implement having an overheating prevention function. The cooking implement (10) of the present invention includes an inner layer (20) which has a sidewall (21) and a bottom (25), and an outer layer (30) which has a shape surrounding an outer surface of the inner layer (20) and is spaced apart from the inner layer (20). The cooking implement (10) further includes a heat transfer member which is provided between the bottom (35) of the outer layer (30) and the bottom (25) of the inner layer (20), so that the inner layer contacts the outer layer below a desired temperature, and so that the inner layer is spaced apart from the outer layer above the desired temperature. Therefore, in the present invention, even if the cooking implement is heated for a long time, the cooking implement is prevented from overheating.

### TECHNICAL FIELD

The present invention relates, in general, to cooking implements having double-ply bottom structures and, more particularly, to a cooking implement which prevents from heating over a desired temperature.

### BACKGROUND ART

Generally, in cooking implements, such as pots and fry pans, the bottom of a cooking implement is heated in order to cook food. As heat is concentrated on the bottom, the food may be burned or scorched.

To prevent burning and scorching, double-ply pots, the bottoms of which have double-ply structures, have been proposed. However, the bottom of the conventional double-ply pot merely has a structure in which two layers are laminated together.

### DISCLOSURE

[Technical Problem]

In conventional cooking implements such as double-ply pots, there is a problem in that they have no function to prevent overheating. Therefore, if a user is not careful while cooking food, a cooking implement overheats so that the food may be burned and, as well, fire may break out.

Accordingly, the present invention has been made keeping in mind the above problems occurring in the prior art, and an object of the present invention is to provide a cooking implement which has an improved structure, so that, even if the cooking implement is mistakenly heated for a long time, the cooking implement is prevented from overheating, and which is manufactured such that a desired overheating temperature can be appropriately set according to the kind of cooking implement.

[Technical Solution]

In order to accomplish the above objects, the present invention provides a cooking implement having an overheating prevention function, including: an inner layer having an open upper end so that a food to be cooked may be placed in the inner layer, and comprising a sidewall and a bottom integrated with each other; an outer layer having a shape surrounding an outer surface of the inner layer and coupled to an outer edge of the inner layer while being spaced apart from the inner layer by a predetermined distance; and a heat transfer member provided between a bottom of the outer layer and the bottom of the inner layer, so that the inner layer is in contact with the outer layer below a desired temperature such that heat transfer by conduction is performed through the heat transfer member, and so that the inner layer is spaced apart from the outer layer above the desired temperature such that the heat transfer by conduction is interrupted.

The heat transfer control member may comprise an uneven surface formed by bending and protruding upwards the bottom of the outer layer, so that the uneven surface is intermittently brought into contact with the bottom of the inner layer according to the heating temperature. Alternatively, the heat transfer control member may comprise a conduction protrusion mounted on the bottom of the outer layer, so that contact of the conduction protrusion with the bottom of the inner layer is controlled according to heating temperature.

The conduction protrusion may have a U-shaped cross-section.

The cooking implement may further include at least one vent hole formed through the outer layer. The vent hole may be formed through the bottom of the outer layer. The number and size of vent hole may be determined according to the intended purpose of the cooking implement.

[Advantageous Effects]

In the present invention having the above-mentioned construction and operation, even if the cooking implement is mistakenly heated for a long time, the cooking implement is prevented from overheating. Furthermore, the inner layer of the cooking implement is prevented from being heated over a cooking temperature suitable for a particular kind of food. As such, the cooking implement of the present invention can cook the food at an optimum temperature, thus increasing its marketability.

Although the preferred embodiment for illustrating the cooking implement having the overheating prevention function has been disclosed, the present invention is not limited to the preferred embodiment. Those skilled in the art will appreciate that various modifications, additions and substitutions are possible, without departing from the scope and spirit of the invention as disclosed in the accompanying claims.

When using the cooking implement of the present invention, substances in the inner layer of the cooking implement are prevented from being burned, thus preventing a scorched smell, which is a problem occurring in the conventional arts. Furthermore, because substances in the inner layer of the cooking implement are not burned, the cooking implement can maintain its clean state.

### DESCRIPTION OF DRAWINGS

FIG. 1 is a partially broken perspective view of a cooking implement, according to an embodiment of the present invention;

FIG. 2 is a sectional view of the cooking implement according to the present invention;

FIGS. 3 and 4 are views illustrating an overheating prevention operation of the cooking implement according to the present invention;

FIGS. 5 and 6 are views illustrating a conduction part of the cooking implement according to the present invention;

FIGS. 7 and 8 are a partially broken perspective view and a sectional view of a cooking implement, respectively, according to another embodiment of the present invention; and

FIGS. 9 and 10 are a partially broken perspective view and a sectional view of a cooking implement, respectively, according to a further embodiment of the present invention.

### BEST MODE

Hereinafter, preferred embodiments of the present invention will be described with reference to the attached drawings, and reference now should be made to the drawings, in which the same reference numerals are used throughout the different drawings to designate the same or similar components.

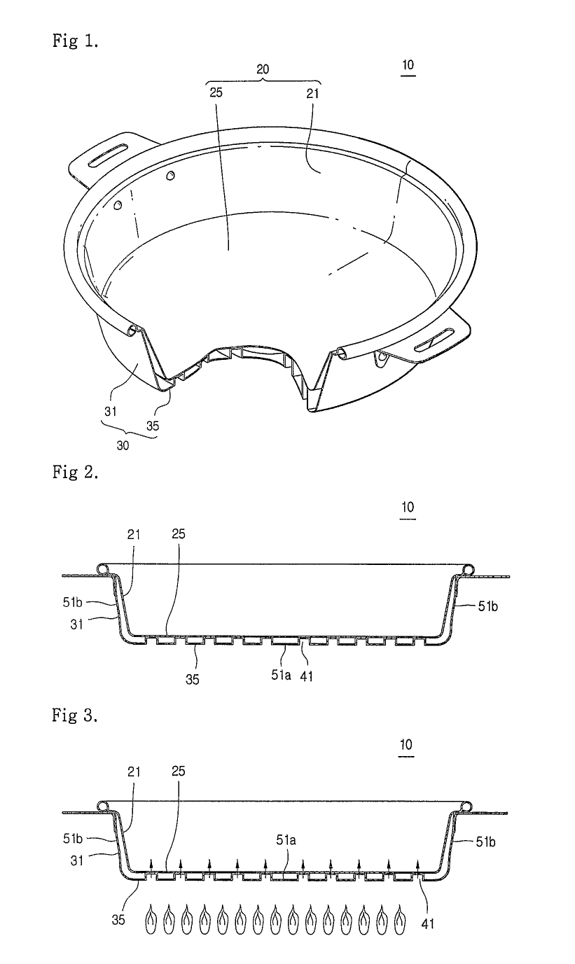

FIG. 1 is a partially broken perspective view of a cooking implement, according to an embodiment of the present invention. FIG. 2 is a sectional view of the cooking implement.

As shown in the drawings, the cooking implement of the present invention, which is designated by the reference numeral 10, is open at an upper end thereof, such that a separate lid may be seated on the open end thereof. Furthermore, the cooking implement includes an inner layer 20 and an outer layer 30. The inner layer 20 is provided with a sidewall 21 and a bottom 25. The outer layer 30 is also provided with a sidewall 31 and a bottom 35 and has a shape surrounding the outer surface of the inner layer 20. The inner layer 20 and the outer layer 30 are coupled at their upper edges to each other.

The outer layer 30 and the inner layer 20 are spaced apart from each other by a predetermined distance, thus forming a space therebetween. A heat transfer member is provided on the bottom 35 of the outer layer 30 and enables or interrupts heat transfer by conduction.

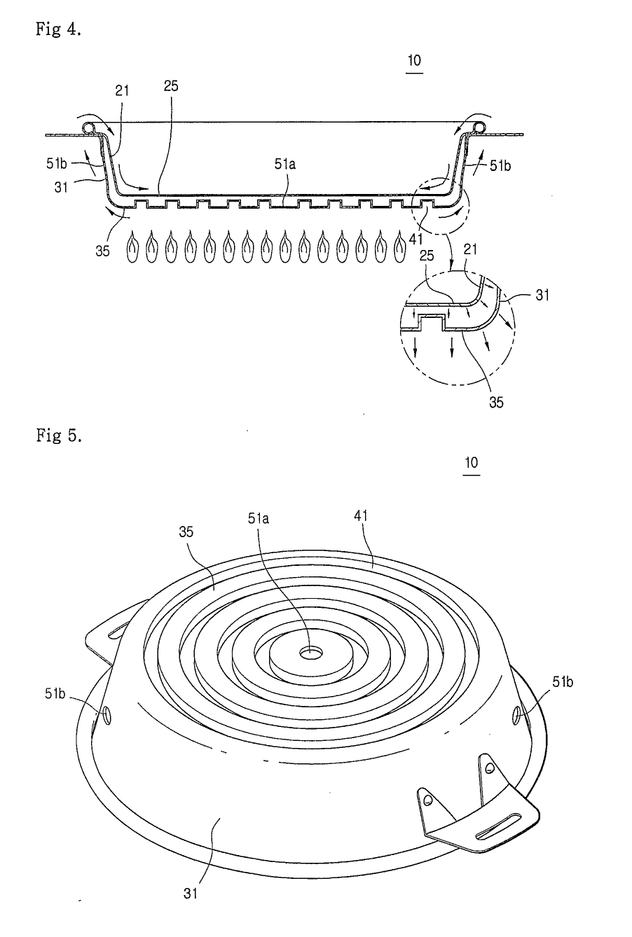

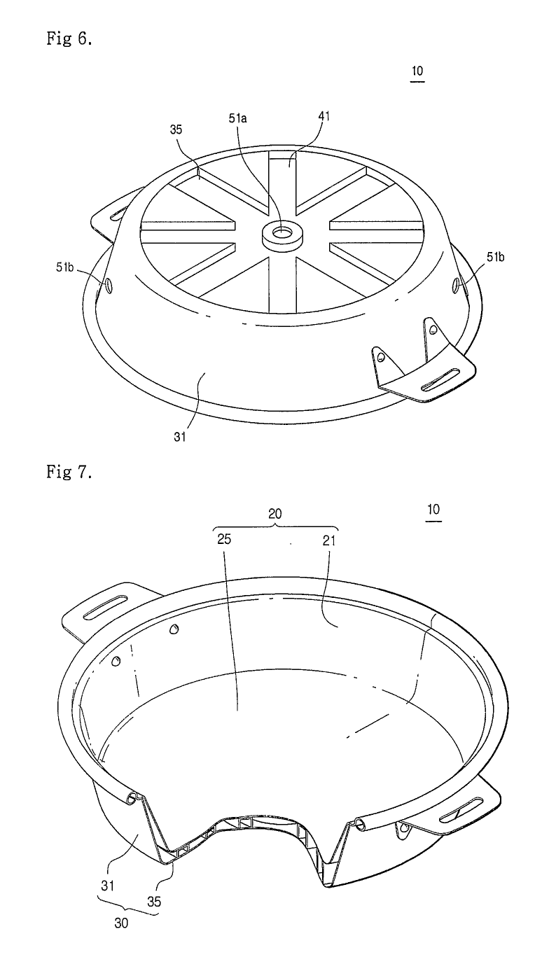

The heat transfer member comprises an uneven surface 41 which is formed by bending portions of the bottom 35 of the outer layer 30, as shown in the drawings. As shown in FIG. 5, the uneven surface 41 may be configured as a concentric circular shape. Alternatively, the uneven surface 41 may be configured as a radial shape.

Furthermore, vent holes 50a and 50b are formed through the outer layer 30. Preferably, the vent hole 50b is formed through the sidewall 31 of the outer layer 30, and the vent hole 50a is formed at a central portion through the bottom 35. That is, the cooking implement of the present invention comprises the inner layer 20 and the outer layer 30, and the space is defined between the inner layer 20 and the outer layer 30. Here, if the space between them is airtightly sealed, when the cooking implement 10 is heated, air in the space expands due to heat. Thus, due to the expansion of air, the inner layer 20 or the outer layer 30 may be deformed. Besides, there is a probability of breakage or explosion of the cooking implement 10.

For preventing these, in the present invention, the vent hole 50b to discharge air outside is formed in the outer layer 30. Meanwhile, in a process of washing the cooking implement 10, water may flow into the space between the inner and outer layers. However, the water that flows into the space is discharged outside through the vent hole 50b, which is formed at the central portion in the outer layer 30.

The operation of the present invention having the above-mentioned construction will be described herein below.

In the cooking implement 10 of the present invention, the uneven surface 41 of the outer layer 30 is in contact with the inner layer 20 at normal temperature, as shown in FIG. 3. As such, while the uneven surface 41 is in contact with the inner layer 20, if the cooking implement 10 is heated to cook food, heat applied to the outer layer 30 is transferred to the inner layer 20 through the uneven surface 41 of the outer layer 30, so that the inner layer 20 is also heated.

Typically, heat is transferred from a higher-temperature region to a lower-temperature region. Such heat transfer is performed by heat conduction, heat convection, heat radiation or a combination thereof. Among them, heat conduction is a phenomenon in which thermal energy flows through a substance from a higher-temperature region to a lower-temperature region without physical movement, that is, thermal kinetic energy is transferred by the mechanisms of conduction electron and/or lattice vibration. Meanwhile, if a temperature difference exists in fluid (gas or liquid), densities become different according to the position in the fluid. In this case, a region of low density ascends, but a region of high density descends, so that partial circulation of the fluid occurs. Heat transfer by such physical movement is called heat convention.

Heat radiation means transmission of heat in the form of thermal rays emitted from the surface of a solid. Thermal rays are a kind of electromagnetic wave. Heat transfer through a vacuum is performed by such a heat radiation mechanism. Furthermore, heat transfer is involved in heating, cooling, heat exchange, heat insulation, cold insulation, etc.

In the cooking implement of the present invention, heat conduction is performed through the uneven surface 41, and heat is transferred to the inner layer 30 by heat convection and radiation in the space defined between the inner and outer layers.

The outer layer 30 and the inner layer 20 expand, when heated, due to thermal expansion. As heating is processed, the inner layer and the outer layer, which contact each other at an initial stage, are separated by such thermal expansion. Then, the inner layer is heated by an indirect heating manner, but not a direct heating manner through the outer layer.

At this time, the outer layer 30 is directly heated by a heat source to a temperature higher than that of the inner layer 20, which is heated by the indirect heating manner. Consequently, the outer layer 30 expands more than does the inner layer.

As described above, when the cooking implement 10 of the present invention is heated by a predetermined temperature, the uneven surface 41 of the outer layer 30, which has been brought into contact with the inner layer 20, moves away from the inner layer 20. Thereby, heat conduction between contacting surfaces is interrupted. As such, when the heat conduction by the uneven surface 41 is interrupted, a temperature difference between the inner layer 20 and the outer layer 30 further increases. That is, the outer layer 30 further expands due to heat being directly transmitted from below the outer layer 30, while the inner layer 20 expands less than the outer layer 30 because the heat conduction through the uneven surface is interrupted. Thus, the outer layer 30 and the inner layer 20 become spaced further apart from each other.

In this state, in which the inner layer 20 and the outer layer 30 are spaced apart from each other, heat conduction is performed only at the edges which contact each other. Therefore, heat is transmitted from the sidewall of the inner layer 20 to the central portion thereof. As a result, there is an advantage in that heat is evenly supplied to the inner layer 20. That is, heat is concentrated on the central portion of the bottom of the inner layer 20 by the uneven surface 41 below a desired temperature. When the temperature of the cooking implement reaches the desired temperature, the uneven surface 41 move away from the bottom 25 of the inner layer 20, thus interrupting heat transfer by conduction through the bottom 25. Then, heat transfer by conduction is performed only from the edge of the inner layer 20 to the central portion. Accordingly, the inner layer 20 maintains a constant temperature.

Furthermore, heat is also transferred from the outer layer 30 to the inner layer 20 by convection through the space defined therebetween. Here, air, which is expanded by an increase in temperature, is discharged outside through the vent holes 50a and 50b, thus ensuring safety. Meanwhile, heat transfer by radiation is performed regardless of whether the uneven surface 41 is in contact with, or spaced apart from, the inner layer 20.

As such, when the cooking implement 10 of the present invention is heated over a desired temperature, heat transfer by conduction through the bottom thereof is interrupted. Generally, most heat is transferred from the heat source to the cooking implement 10 by conduction through the bottom which directly faces the heat source. In this regard, the cooking implement of the present invention can control the heat transfer by conduction through the bottom. Therefore, when manufacturing the cooking implement of the present invention, a contact area of the uneven surface 41 and the number and size of vent holes 50a and 50b should be adjusted according to the intended purpose in consideration of cooking temperature, for example, a temperature of a rice kettle, a temperature of a fry pan for making batter-fried food, or a temperature of a cooking implement for cooking fish.

Meanwhile, heat expansion is affected by the thickness of the inner and outer layers of the cooking implement 10. Because the cooking implement of the present invention is manufactured such that there is a difference in thickness between the inner layer and the outer layer, the present invention efficiently uses heat expansion. For example, if the outer layer is thicker than the inner layer, the structural stability of the cooking implement is ensured.

As examples of applications of the present invention, when it is desired to apply the cooking implement of the present invention to a rice kettle, mainly used for boiling rice, the cooking implement is manufactured such that the uneven surface 41 becomes spaced apart from the inner layer between 100˜110° C. When it is desired to apply the present invention to a cooking implement, mainly used for making batter-fried food, the cooking implement is manufactured such that the uneven surface 41 is spaced apart from the inner layer between 180˜210° C.

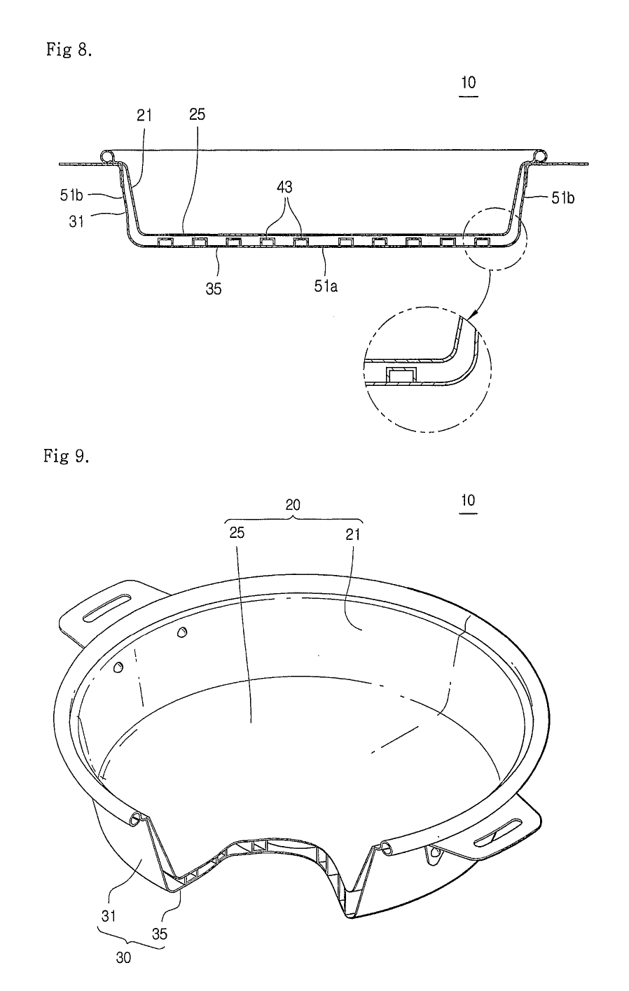

Another embodiment of the present invention is shown in FIGS. 7 and 8.

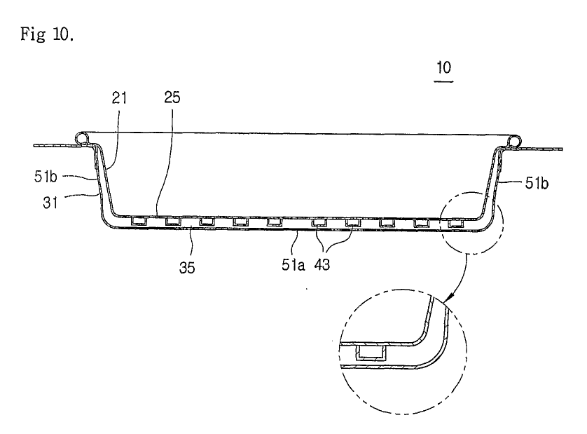

In this embodiment, a bottom 25 of an outer layer 30 is planar without an uneven surface 41 on the outer layer 30, but a conduction protrusion 43 is provided on the bottom 25 of the outer layer 30. In a further embodiment shown in FIGS. 9 and 10, a conduction protrusion 43 is provided under a bottom of an inner layer 20. In each embodiment, the conduction protrusion 43 has a U-shaped cross-section such that sufficient contact area is ensured.

1. A cooking implement having an overheating prevention function, comprising:
an inner layer having an open upper end such that a food to be cooked is placed in the inner layer, and comprising a sidewall and a bottom integrated with each other;
an outer layer having a shape surrounding an outer surface of the inner layer and coupled to an outer edge of the inner layer while being spaced apart from the inner layer by a predetermined distance; and
a heat transfer member provided between a bottom of the outer layer and the bottom of the inner layer, so that the inner layer is in contact with the outer layer below a desired temperature such that heat transfer by conduction is performed through the heat transfer member, and so that the inner layer is spaced apart from the outer layer above the desired temperature such that the heat transfer by conduction is interrupted.

2. The cooking implement according to claim 1, wherein the heat transfer control member comprises an uneven surface formed by bending and protruding upwards the bottom of the outer layer, so that the uneven surface is intermittently brought into contact with the bottom of the inner layer according to heating temperature.

3. The cooking implement according to claim 1, wherein the heat transfer control member comprises a conduction protrusion mounted on the bottom of the outer layer, so that contact of the conduction protrusion with the bottom of the inner layer is controlled according to heating temperature.

4. The cooking implement according to claim 3, wherein the conduction protrusion has a U-shaped cross-section.

5. The cooking implement according to claim 1, further comprising:
at least one vent hole formed through the outer layer.

6. The cooking implement according to claim 5, wherein the vent hole is formed through the bottom of the outer layer.
